(19) United States
(12) Patent Application Publication
(10) Pub. No.: US 2012/0256373 A1
(43) Pub. Date: Oct. 11, 2012

(54) Portable electronic scoreboard for officiating a sporting game

(76) Inventors: Wilson Tam, Markham (CA); Hao Ran Gu, Markham (CA)

(21) Appl. No.: 13/066,067

(22) Filed: Apr. 7, 2011

(51) Int. Cl. A63F 13/00

(52) U.S. Cl. 273/148 R

(57) ABSTRACT

A portable scoreboard system comprising of a microcontroller running a software algorithm that keeps score of a sports game and officiates the game to ensure fair play according to the rules of the sport. The official rules of all the sports are stored in the device memory. The updating of the score is carried out with wireless remote control modules worn by the players and/or users. The score is only updated when the algorithm has confirmed no game rule violations. The real time score information is then displayed on the scoreboard panel plus appropriate audio sounds are played. Game related scores and user settings are stored into memory on a real time basis and can be retrieved externally for post-game analysis.

### BACKGROUND OF THE INVENTION—FIELD OF INVENTION

The present invention relates to an electronic scoreboard system used in sports for keeping track of scores in real time and automatically officiating the game according to the set rules for the particular game.

### BACKGROUND OF THE INVENTION

To sustain a healthy and balanced lifestyle, sports and fitness have always been an integral part of people's lives. This includes people of all ages from youths to seniors, participating from community level recreational sports to competitive matches and organized sport tournaments. With this growing demand and popularity for sports and games amongst both amateur and professional sport athletes, there exists a need for an affordable and portable scorekeeping system, which has the capability to self officiating the game based on official rules of the sport under play. Such system should also allow players and spectators to easily see the score and the game status.

Most scoreboards commonly found in use today are rather large in size and are permanently mounted inside a venue. These units are expensive to fabricate and cannot be easily transported to another playing field or location. Portable scoreboards have more general application because they allow the scoreboard to be set up and used in many different venues. But as described further in the proposal, existing portable scoreboards are very limited in functionality and require an excess level of user input.

Various mechanically built and/or electrically controlled scoreboards have been developed over the years, ranging from simple flip-cards or peg-boards to large scale electronic scoreboards that are permanently installed inside arenas or venues. However, these are mostly cumbersome to use and often restrictive in functionality and difficult to adapt to different sports. Large scale scoreboards are typically very expensive and can not be easily transported to other locations.

The quest is to develop a scoreboard system that is versatile, customizable, easy to use, and most importantly, has the built in capability for scorekeeping based on the official rules for the chosen sport. A portable scoreboard would allow players to setup and used in different locations, and provide a more personalized score keeping system. It would also allow for ease of storage when not in use. A scoreboard must also be easily readable by players as well as spectators from an appropriate distance that varies based upon the game and the venue. Large, easy-to-read characters and numerical displays are therefore desirable.

A well designed scoreboard will definitely enhance the players' overall experience in playing sports and makes it much more enjoyable and engaging in the activity. Overall, this would motivate people to achieve a more active and healthy body and fitness level.

It would be advantageous to provide an improved method and system for keeping score. There is currently no complete system that addresses each of these features in a single apparatus. The present invention addresses these needs and provides other benefits not previously found in portable scoring devices of the prior art.

### BACKGROUND ART

Without a scoreboard, players themselves would try to keep track of the score while they play the game. Plus, spectators attending the game would not be able to get a real time status on the score and who is winning or loosing. It is the competitive aspect of sports that motivates people to play and stay active, and the single most important element of any game is the score. Often time, a common problem encountered during long rallies or matches, is that the one keeping score might loose track of the score and might cause some degree of confusion in the players, resulting with some instances of arguments or disagreements between the two opposing teams. This disrupts the flow of the game and reduces the overall enjoyment in playing, as well as watching, the game.

The most basic score keeping method is by using pencil and paper, but obviously, this method has many shortcomings. A basic scoreboard would alleviate some of the problems and allow the players' to concentrate and enjoy playing the game. A more sophisticated scoreboard, such as the proposed invention, would further enhance the experience by providing additional capabilities and features that would solve many of the deficiencies found in existing arts.

Existing prior arts ranged from those where scores are changed or updated manually by hand, such as using “pen and pencil”, “chalk and chalkboard”, “flip-cards” or “peg-boards”, to more sophisticated large-scale computer controlled scoreboard fixtures installed permanently inside arenas and stadiums.

Numerical flip-cards are very restrictive in terms of the amount of scoring information that can be tracked and displayed and are cumbersome to use. It often requires someone, such as a spectator or a referee on the side line to update the score as the game progresses.

Pegboards are simple to use, but require that all of the possible numbers be shown, thereby increasing the overall size and limiting the maximum score.

All the above mentioned prior arts lack the time keeping capability for sports that require a game clock, example of time sensitive sports may include basketball, hockey or soccer.

Similarly, mechanical “scoring drums” or “rotary numbered discs or wheel” type of scoreboards consumes an excessive amount of space and overall weight, as it needs to accommodate a sufficiently large diameter display for all the digits. Thus limiting their ability to be portable, and often time these mechanical fixtures consume a lot of power to operate and maintain. Similarly, these mechanical scoreboards require a dedicated person to update the score as the game progresses.

Some prior arts use electromechanical displays that contain numerous moving parts with motors, switches and relays. These types of displays are also very costly to produce, consuming high amounts of power to operate and prone to damage upon impact. Other prior arts might use lamps or light bulbs for the display, which are power inefficient, high maintenance and generating excessive heat.

As for electronic based prior arts, most are very large in size and are not suitable for transporting and portable use on a routine bases. These scoreboards are usually installed permanently inside an arena or playing field, and typically only a single board would be installed to serve the entire facility. This obviously limits its use when multiple games are simultaneously in play (ex. a gymnasium with multiple tennis courts). Thus, these existing large venue scoreboards lack the ability to allow each group of players to have their own scorekeeping system, setup and configured to the way they like it to be.

Also, prior arts are limited to keeping score of only a few types of sports, and can not be adapted to use for a variety of sports. Although some scoreboards claim to support different sports, only the information displayed is changed depending on the type of sport selected, which leads into describing the key differentiator between all prior arts with the current proposed invention.

The one fundamental feature of functional all existing prior arts lack is the built in capability to automatically officiate the game according to official rules of the sport selected. All prior arts utilize a holistic approach to scorekeeping, meaning these products are simply a collection of individual counters to be used for keeping track of different events, scores of scenarios inherited in each sport under play. These prior arts lack the capability of incorporating the official game rules into the score keeping sequence. This is one key limitation of existing prior arts and this is one area where the proposed invention addresses. Basically, the proposed invention allows players themselves to play the game without worrying about the rules of how to keep score of the game as this functionality is built-in to the system upon having selected the type of sport. This feature, together with the remote wireless modules worn by the players, achieves the true self officiating experience in scorekeeping, thus allowing the players to fully engulf in the sport they are playing.

Existing prior arts are often very difficult to configure and control since the user interfaces typically consist of many rows of buttons, each dedicated to control a specific numerical counter or function on the scoreboard. Also the user input panel is usually located at the back side of the scoreboard, which makes it very inconvenient for the player themselves to control while looking at the front-side of the display, especially for the case when the scoreboard is mounted on the wall. Based on this limitation, existing scoreboards often time require a dedicated person or party familiar with the official rules of the game to be present on the sideline to observe and officiate the game in progress and to update the score directly on the scoreboard.

A third person or party is someone that is not involved in the current game and is situated outside of the playing area (i.e. court or playing field) during the duration of play. For competitive games, the officiating referee might be responsible for the scorekeeping, but for semi-competitive or recreational matches, such a person might not always be present. Therefore, the propose scoreboard is a system that allows the players themselves to operate score changes through a simple push of a single button on the wireless remote, with nearly no interruption to the game. Also, audible tones will be generated by the scoreboard each time the score is updated to indicate a change is made, and these tones can be selected as pre-recorded voice messages announcing the current score or game information or as simple as a beep of a horn.

Furthermore, for the case where the players themselves have to update the score on existing prior arts, this would require the game to be paused momentarily in order for the person to walk up to the scoreboard or control panel to initiate the score change. This obviously disrupts the overall flow of the game and degrades the overall experience of playing the sport.

For prior arts where a remote control capability is used to control the scoreboard, two types are used; a cable wire or through over the air wireless. However, all of these prior arts do not provide a remote control unit that is non-intrusive enough to be practically wearable by the players themselves during play. In competitive sports, players are not allowed to carry or wear anything in excess of what the sport requires, with exception of course the required sports equipment and apparel. In the present invention, the wireless remotes are designed to be miniature and lightweight, and can be integrated into the players' apparel, either as a wristband, wristwatch, necklace, or a clip-on-pin attached to the shirt or cap.

In terms of game data logging, storage and retrieval, most prior arts do not support these capabilities. So in these cases, the data is lost or erased when the scoreboard is reset or power off. The proposed invention supports all of these features, plus allows the data to be transferred to an external source for further processing and analysis (i.e. post processing on a computer application showing game trends and statistics).

### SUMMARY OF THE INVENTION

The portable scoreboard system of the present invention comprises of a microcontroller running a software algorithm that keeps score of a sports game and officiates the game to ensure fair play according to the rules of the sport. The official rules of all the sports are stored in the device memory. The updating of the score is carried out with wireless remote control modules worn by the players and/or users. The score is only updated when the algorithm has confirmed that there are no game rule violations. The real time score information is then displayed on the scoreboard panel plus appropriate audio sounds are played. Game related scores and user settings are stored into memory on a real time basis and can be retrieved externally for post-game analysis.

### BRIEF DESCRIPTION OF THE DRAWINGS

Reference will now be made to the accompanying drawings in which:

FIG. 1 shows a front and open view of a foldable enclosure, exposing the large digital displays and user interface with key panel.

FIG. 2 shows a closed form of an embodiment of the scoreboard, exposing the folding hinge and access to the battery compartment.

FIG. 3 shows a further embodiment of the right side view of the embodiment exposing the controls and auxiliary input/output ports. The display panels are fully opened with the supporting leg fully extended.

FIG. 4 shows a further embodiment of the left side view of the embodiment, with panels opened and supporting leg extended. Also shown is a panel installed in two possible configurations, either vertically to be used as a team name plate (example: visiting team name or logo and home team name or logo), or it can be mounted horizontally to be used as a sun visor to improve display visibility under bright sun light when playing outdoor.

FIGS. 5A and 5B shows embodiments of possible wearable remote control devices, with two samples illustrated, but not limited to these illustrations.

FIG. 6 shows in block diagram form, an embodiment of a hardware microcontroller and its auxiliary electronic components consisting of the internal memory, user keypad interface, a real time clock and calendar module and a wireless receiver.

FIGS. 7, 8, 9 and 10 shows, in flowchart form, a general embodiment of the method of the embedded software algorithm where all decision making employed in the system during play as part of the officiating capability is applied

FIGS. 11 and 12 shows two possible embodiments of the scoreboard display.

### DETAILED DESCRIPTION OF THE PREFERRED EMBODIMENT

The proposed invention is a scoreboard that utilizes a compact, lightweight, robust design that allows for easy transport in any sport bag or backpack, and can be easily setup on site, and simple to operate during the game. In a tournament type of sporting venue, or a semi-competitive club found at a local recreational community centre, this product would allow different groups of players to have access to their own scoring system. For example, in a gymnasium or arena, with multiple badminton courts setup, each court could independently keep their own scores.

The purpose is to provide a graphical depiction of the physical appearance, and the application of the embodiment. Also included are system diagrams showing the hardware architecture in conjunction with the software algorithms used in the design of the invention.

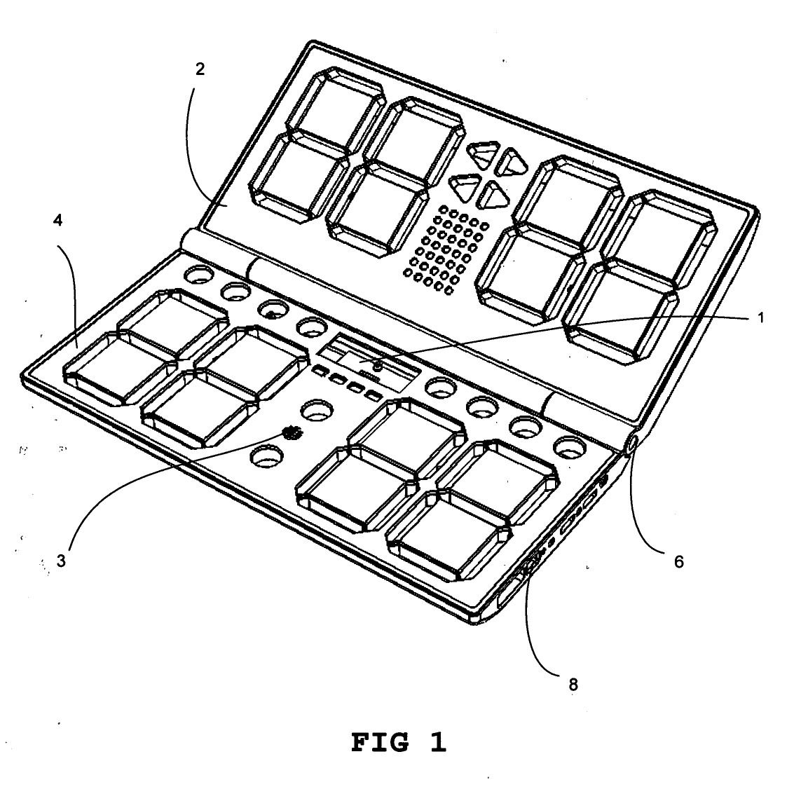

With reference to FIG. 1, the device of the present invention has a foldable enclosure (2) and a scoreboard display (4). The foldable configuration allows for a high degree of portability during transport to the location and storage. Also, by having the actual displays folded inward will protect the surface of the display from scratches and damage when not in use. A folding hinge (6) uses a multiple gear and ball-joint design that allows for three degree of movement between the two halves of the enclosure and the supporting leg extension (10).

A very simple user interface (1) is integrated into the invention consisting of an alphanumeric menu-driven LCD module, controlled by a set of multi-functional keys (148), and it can be conveniently accessed from the front panel. The interface is very intuitive, with a menu showing settings, sport selections and options, allowing the user to easily make the required changes or update for either a fully customized setting or simply use of the defined game rules.

An outlet for the speaker (3) is shown, with auxiliary audio output available on the side panel (8).

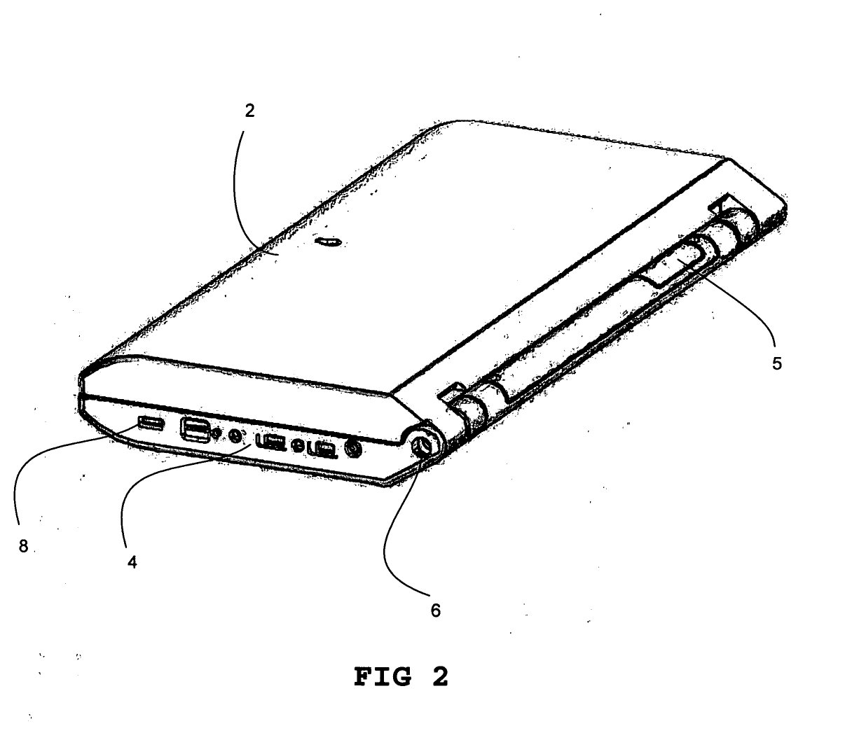

FIG. 2 shows an embodiment of the scoreboard enclosures in a closed form (2 & 4), when the device is not in use, exposing the folding hinges (6) and the supporting leg extension (10) is stored away into the compartment (4). Also shown is the battery compartment (5) hidden in the spine of the hinge. The side panel (8) is also shown exposing the various auxiliary output and input ports available, including the computer interfacing connector, audio output jack.

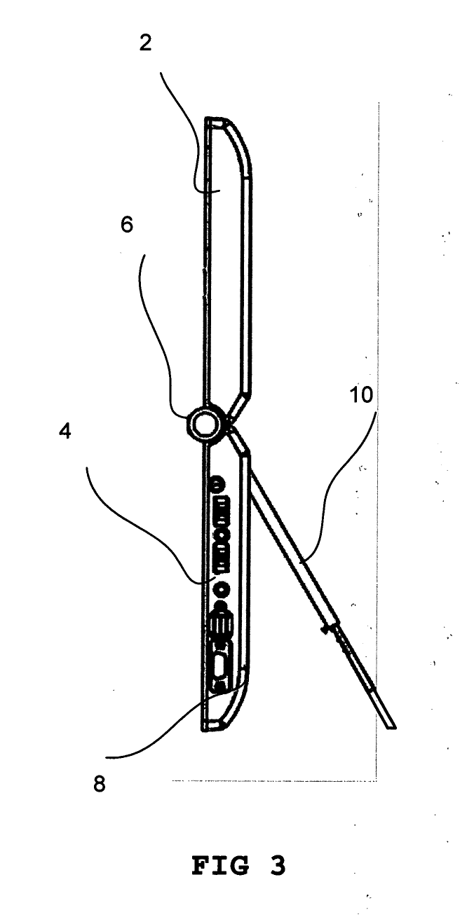

Reference is now made to FIG. 3 that shows an embodiment of the supporting leg extension (10). This mechanism is built into the back side of the bottom enclosure (4) to provide support when the scoreboard is opened in an upright or tilted position. Together with the folding hinge (6) and the extension leg (10), this design provides a flexible mounting configuration of the scoreboard allowing for different configurations and installation, on various surfaces including, but not limited to; table top, vertical glass panel mount, wall mount or fence installed.

One of the key design objectives is to maximize the visibility of the digital display while still minimizing the overall size of the scoreboard. This is achieved with a large aspect ratio on the digit size in comparison to the dimensions of the overall enclosure (2 & 4). Plus the foldable design allows for greater display surface area when in use, but half the size during carriage and storage.

The digital displays consist of super bright and high efficiency solid state LEDs providing a robust and reliable operation. LEDS are also low power consumption, allowing the system to be battery powered.

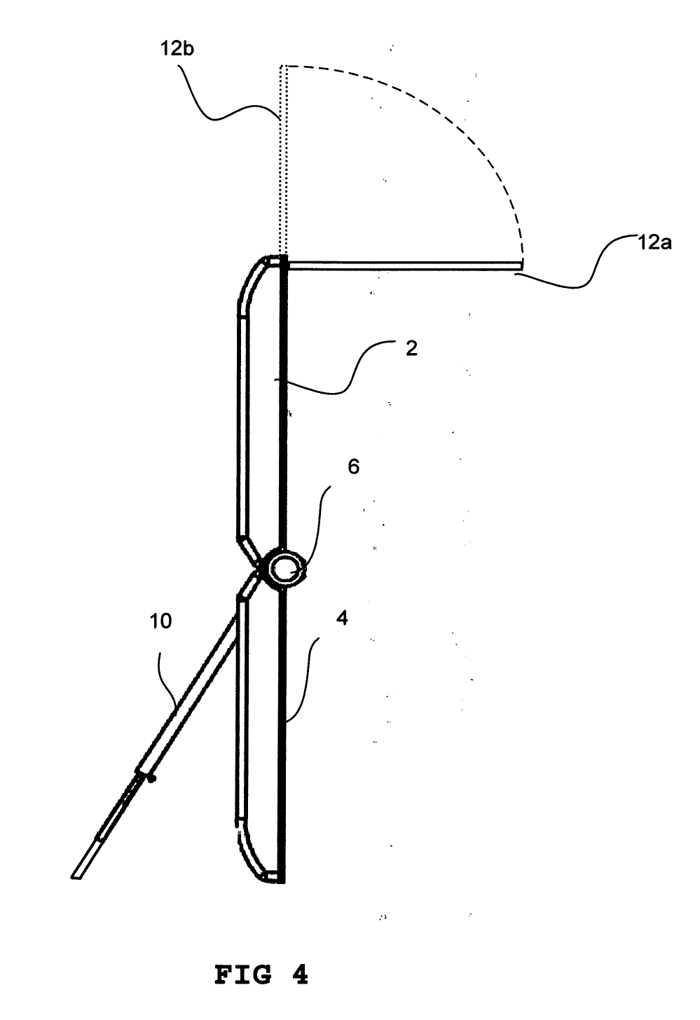

With reference to FIG. 4, the construction provides a high visibility display in both indoor and outdoor environments, i.e. under the bright sun or in night time conditions, with a visor panel (12a) integrated into the enclosure (2). This visor panel can also provide to a certain degree of protection from rain or snow, assuming the conditions are still suitable for playing the sport.

When not in use, the visor panel (12b) can also be installed in an upright vertical position to be used as a personalizing team or player nameplate. This enhances the usability of the scoreboard compared to the traditional “HOME” and “GUEST” labels used on many prior arts.

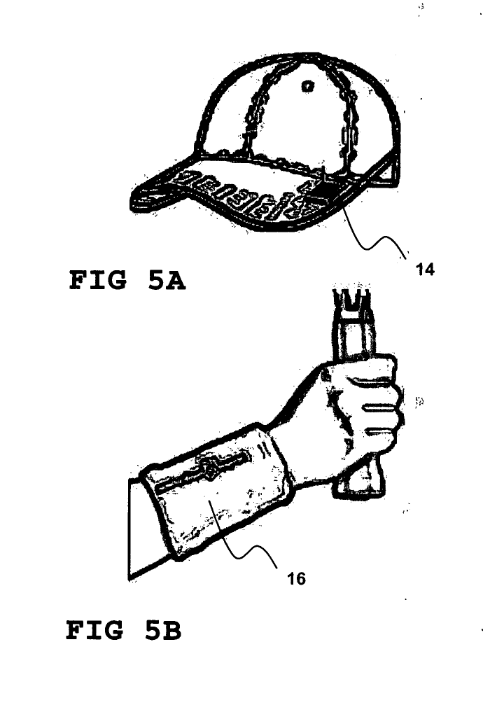

With reference to FIGS. 5A and 5B, the wireless remote modules (14 & 16) can be integrated into the apparel worn by the players to allow for the instantaneous updating of the score during play. These remotes are very small devices that are button cell battery powered. Only two sample applications are shown. It can be worn as a wrist band or wrist watch or as part of the cap. These remote modules are factory paired electronically and synchronized with the scoreboard. New remote modules can be paired with a scoreboard using the user interface function.

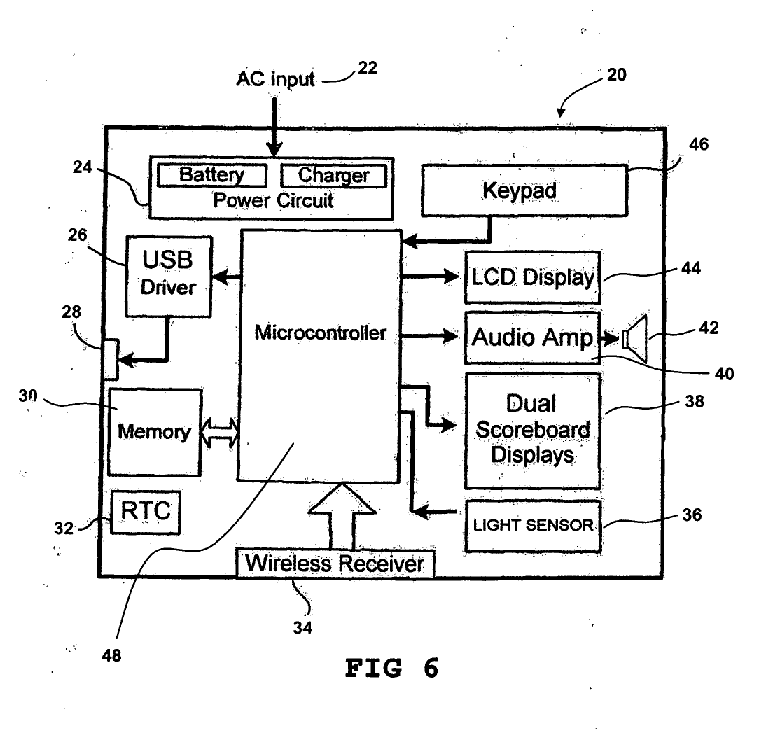

With Reference to FIG. 6, the core of the scoreboard system (20) is a high performance microcontroller (48) that controls all internal and external functionalities of the system. The system is powered by a dual power supply allowing either a battery or AC input source (22), with a built in battery charging circuit (24) in the case where rechargeable batteries are used. The system also has indications showing low battery and full battery states. With the batteries, it enhances the portability of the product without compromising the overall weight too much as the overall system consumes very little power.

The battery compartment is integrated as part of the folding hinge or “spine” (with reference to FIG. 1 item 6), achieving a compact design. To save battery power, a built in light sensor circuitry (36) is incorporated to sense the ambient lighting of the environment (indoor and outdoor) and automatically adjusting the intensity of the LED displays (38) for optimal viewing. The display will also automatically reduce its intensity during non-active or idle periods of the game to save battery power.

An audio amplifier (40) and piezo buzzer (42) is used for audio output of real-time score and game status changes or events. The audio output may be audible tones or musical sequences which are stored in the system memory (30). Alternatively, the audio amplifier could drive an external loud speaker or horn (42) to provide a higher volume audible sound.

As mentioned above, there is a built in memory (30) on the system for non-volatile storage of all game rules of all sports supported, as well as storing of the actual game scores and statistics. Customized user settings and parameters may also be stored in the memory. The data stored may also be transferred to a computer terminal via USB connectivity (26 & 28) for further analysis or processing (example: by team coaches to evaluate the players' or team progress).

To enable wireless connectivity to the remote module worn by the players, it may be a wireless receiver integrated into the system, which has a direct interface to the microcontroller (48).

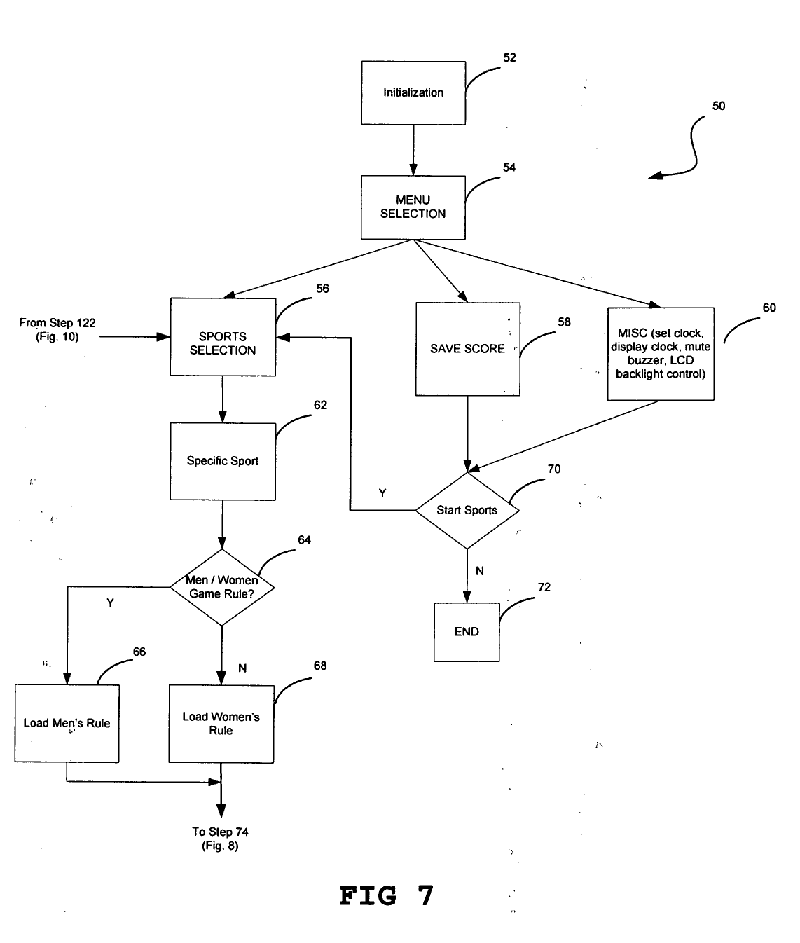

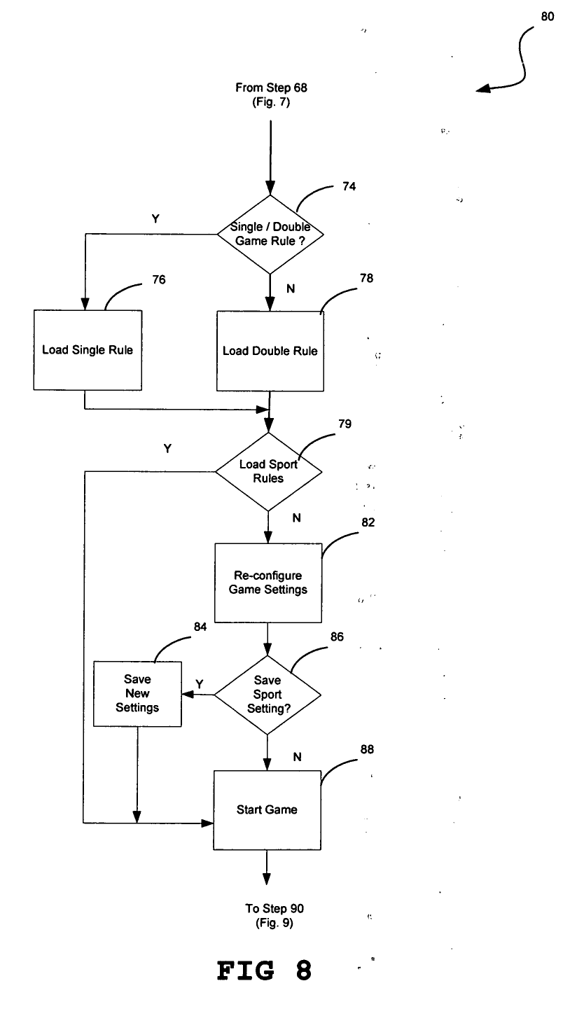

Reference is now made to FIG. 7 and FIG. 8, which show, in a general flowchart form, an embodiment of the initial software algorithm (50) and the methodology used for scorekeeping control. The method (50) relates to a control sequence involving a scoreboard display described above, and the remote controls worn by the players themselves. The control sequence is performed in parallel with the display and the remote controls.

The method (50) begins in state (52) with system initialization. This involves input/output (I/O) port configurations and resetting of software parameters. The system then enters into a state (54) where a Menu Selection is displayed to the user via the LCD graphical user interface. In the Menu Selection, various options and features can be accessed, including Sports Selection (56), Save Score (58), and Miscellaneous Settings (60). In the Sports Selection state (56), users can choose amongst a list of sports previously loaded into the memory; such as basketball, football, badminton, volleyball or hockey. Miscellaneous Settings (60) allow users to update settings for system calendar and clock, game clock, increment or decrement timer, audio buzzer on/off, and settings for transmission of stored game data to external computer terminal.

If Save Score (58) is enabled by the user, this feature will allow the system to log and store continuously to the memory all the events that occur during the entirety of the game. This includes score changes (i.e. increment or decrement), time stamps and other game related statistics. If Save Score (58) is disabled by the user, this function will not be active.

Depending on the type of Sport Selected (56), different game configurations and settings are available for the user to configure (62). These settings can vary depending on the selected sport and based on this, the appropriate rules will be applied. This may include, but not limited to, a singles match versus doubles (74) for court level games such as tennis or badminton, or men versus women (64), or tournament versus single game (78). For example, the game of badminton uses a different scoring system depending on whether players are competing in one-on-one singles or two-on-two doubles, or the number of points per game can vary depending on all men or all women or mixed, or the number of games per match, or the type of deuce/time break play to select. The scorekeeping rules for different sport are not similar.

If the user chooses to keep with the official game settings, then he or she can proceed to the step (88) to Start Game. Users may also load (79) a previously stored setting (from memory) or save custom settings (84 & 86) before proceeding to the step (88) to Start Game.

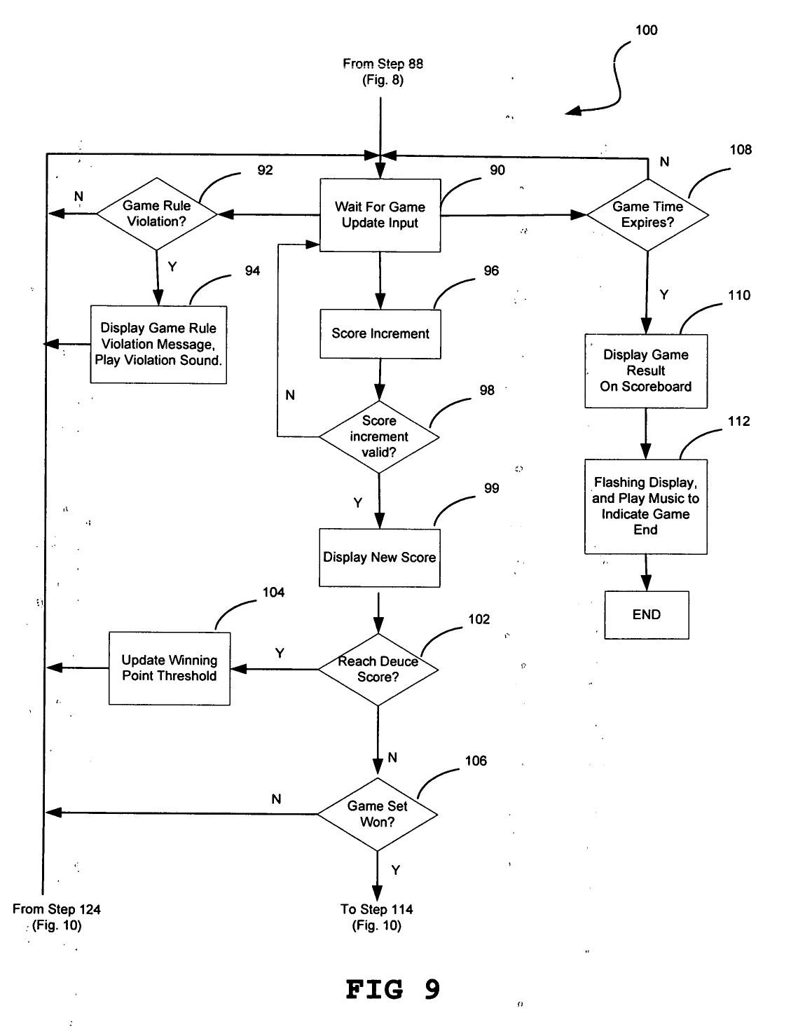

Once all the sports selection and game settings are completed, the user can choose to Save the New Settings (86) or proceed immediately to Start Game (88). FIG. 9 is a continuation of FIG. 8, and it shows the Start Game (88) sequence, and this is where all settings are loaded and the game is now in progress. As the game proceeds, step (90) is a junction state that waits for game update input from the players via the wireless remote modules. Each user initiated score change input is checked by a Game Rule Violation algorithm (92 and 98). Only when the validate results with a pass will the change be registered (96) and actual scoreboard display updated (99) reflecting the new score. This event would also trigger an audible tone to be sounded, indicating to all players that the score has been updated. For the case where an invalid input is made, the change will be revoked and an audible tone will be played to indicate this status (94).

The algorithm (50) has built-in intelligence to ensure sports rule compliance is met. For sports that require a game clock, the state (108) will indicate the end of game by sounding the horn when the clock expires (112).

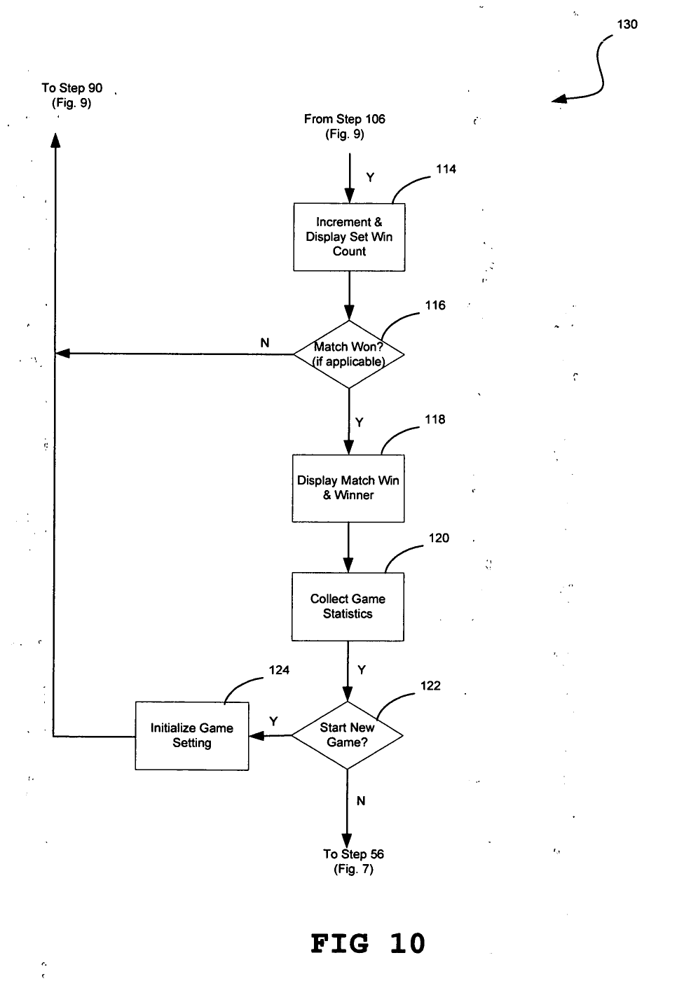

In steps (102 and 104), they monitor the game point progress for the score in playing a duce, and to compare the score with the winning point threshold of the selected sport, and for reporting the intermediate or final game results. The system outputs various information during the game, such as display game points, foul counts, and period count; turning on buzzer for point increment; and playing musical sequence at the end of the game (94). In FIG. 10, which is a continuation of FIG. 9, it shows for sports that require multiple games to be played per match, the system also keeps track of this status in states (106, 114, and 116) in order to determine the final winner.

As mentioned above, if Save Score feature was enabled (58) during game settings, all of these events that occur during the game will be logged into the memory in real time. Various information can be collected during the game, such as points per quarter, time stamps per score change event, game advancement speed, final scores etc. In step (106), when the game is finished, the system has the capability to reconcile all the data collected and prepare the overall statistical game summary (120). The collected information can then be transmitted to a computer terminal for analysis or interpretation by players, coaching staff or other interested parties.

It will be appreciated that the embodiments of the method and system described above determine the winning team by comparing the final game score and with the setting of the selected game (118). Once a game is finished and the winner is determined, the players can restart a new brand game (122) or abort the system.

The entirety of FIGS. 7, 8, 9 and 10 is only a generic flowchart of the overall algorithm and structure, but it must be appreciated that every sport defined in the system has different score keeping rules and regulations, and the system applies variations of the algorithm accordingly. This embodiment illustrates the capability for the user to customize the settings and how the system keeps score and game information according to official game rules.

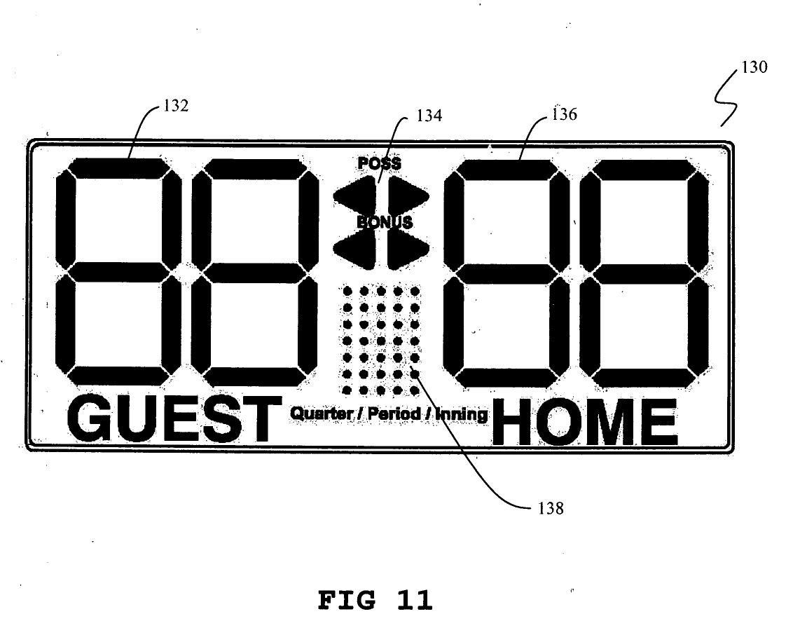

Reference is now made to FIG. 11 which shows the top half of the scoreboard display comprising of the seven-segment digits (132 & 136) for the Guest and Home scores and a centrally mounted dot matrix (138) that can be used as a fifth digit. Possession arrows and Bonus Round arrows (134) are used in some sports such as Basketball.

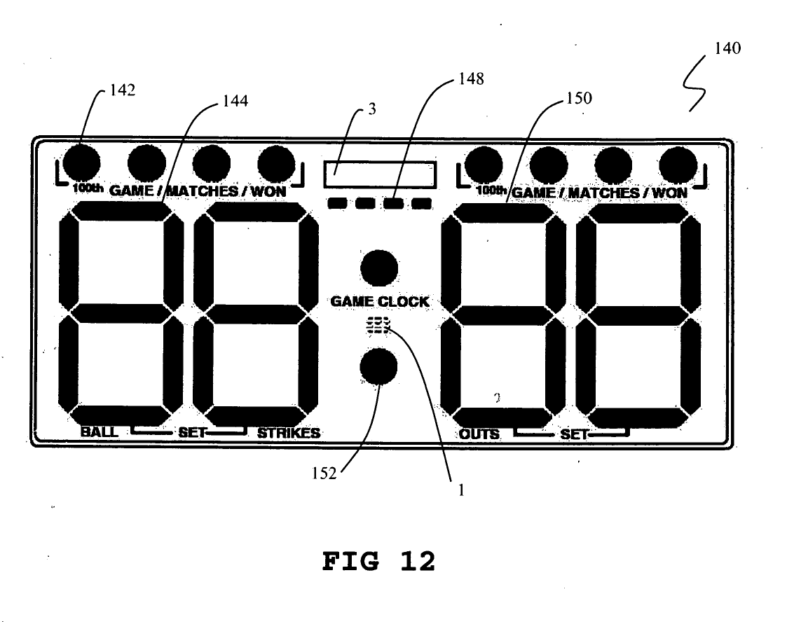

Reference is now made to FIG. 12 which shows the bottom half of the scoreboard display comprising of another set of seven-segment digits (144 & 150) that can be used for either displaying the game clock (152) or additional scores as required by the selected sport. A centrally mounted LCD user-interface (3) and function keys (148) are conveniently assessable by the players. Additional circular LED elements are displayed for both the Guest and the Home teams for keeping track of numbers of games won. A speaker outlet is situated on this panel for the audio output (1).

Although the description above contains many exemplary embodiments, these should not be construed as limiting the scope of the invention. Numerous modifications and variations could be made thereto by those skilled in the art without departing from the spirit and scope of the present invention.

We claim:

1. A portable scoreboard system comprising:
a memory means operative for storing standard official game rules and score point award rules of a plurality of sports games;
an input module operative for selecting a particular game from said plurality of sports games to be monitored by said system, and for entering winning points into said system while playing said particular game;
a microcontroller connected to said memory means and said input module, said microcontroller including a logical algorithm operative to correlate winning point entries from said input module with said official rules to determine fair play of said sports game without violation according to said official rules;
a display means connected to said microcontroller for showing a visual display on a scoreboard in real time game progress information and score display according to said score point award rules.

2. A portable scoreboard system according to claim 1 wherein said sound device connected to said microcontroller and operative to emit an audible signal simultaneously with said visual display and with every entry from said input module.

3. A portable scoreboard system according to claim 1 wherein said input module is a remote device wirelessly connected to said microcontroller.

4. A portable scoreboard system according to claim 1 wherein said memory means is operative for logging all game related scores and statistics with timestamps, said scores and statistics is retrievable through a standard communication protocol for post processing and statistical analysis.

5. A portable scoreboard system according to claim 1 wherein said memory means is operative for storing customized user game settings having selected game rules and score point award rules.

6. A portable scoreboard system according to claim 5 including an interface having an on-board LCD display and electronic keypad for entering said customized user game settings and game rules and score point award rules into said memory and for displaying scores of said game on said LCD display.

7. A portable scoreboard system according to claim 1 wherein said input module is incorporable into equipment worn by at least one participating player of said game for entering scoring points into said system without intervention of a third party.

8. A portable scoreboard system according to claim 7 wherein said input module is incorporated in an equipment selected from the group consisting of wristbands, headbands, visor of a cap, necklace, and a broche with safety pin.

9. A portable scoreboard system according to claim 1 having a foldable compact housing including two enclosures joined together on one edge,by dual hinges.

10. A portable scoreboard system according to claim 1 wherein said sound device has built in audio output of tones and musical sound as feedback to players for various events and conditions encountered during an active game, said audio output of tones and musical sound including a sound indicating a score update, and playing sound of a horn for indicating game clock expiry.

11. A portable scoreboard system according to claim 1 wherein said display means is an LED display having efficient power requirement, durability, shock and impact resistance.

12. A portable scoreboard system according to claim 1 wherein said system includes a power circuit for operating said system with an AC power supply.

13. A portable scoreboard system according to claim 11 including rechargeable batteries chargeable with said power circuit for operating said system alternatively.

14. A portable scoreboard system according to claim 1 including personalized name plates installed on said enclosure for differentiating two score displays for competing players.

15. A portable scoreboard system according to claim 1 wherein said display means are LED displays with name plates installed on a visor worn by said players of said game for providing clear visibility of said LED displays under varying outdoor and indoor lighting environment.

16. A portable scoreboard system according to claim 4 including an output means connectable to an external computer for retrieving said scores and statistics for providing a graphical analysis of all games played and stored earlier in said memory means for tracking progress and performance of said players on a time scale basis for each game played.

17. A method of monitoring and displaying score in real time of a selected sporting event by a portable scorekeeping device comprising,
storing standard official game rules of a plurality of sports games in a memory means in said scorekeeping device,
providing a logical algorithm in a microcontroller located in said device,
addressing said microcontroller to select a sports game to be monitored by said scorekeeping device,
entering a winning point input entry through an input module by at least one participant of said selected sports game into said microcontroller when each winning point is scored during said game whereby said microcontroller correlates said winning point input entry with said standard official game rules of said selected sports game from said memory means to determine fair play of said sports game without violation according to said official rules,
displaying score of said sports game according to scoring rules of said selected game on a display screen of said device after compliance of official game rules of said score input having been verified by said microcontroller.

18. A method of scorekeeping with a portable scorekeeping device according to claim 17 including emitting an audible sound output from said portable device at each winning point entry.

19. A method of scorekeeping with a portable scorekeeping device according to claim 17 wherein said microcontroller addresses said memory means to record said score and statistical data of said sports game in said memory with timestamps, said score and said statistical data being retrievable from said portable device through an output means for post-game analysis and player's performance metrics.

20. A method of scorekeeping with a portable scorekeeping device according to claim 17 wherein customized user game settings for a particular sports game are pre-settable by participants of said sports game.

21. A method of scorekeeping with a portable scorekeeping device according to claim 17 wherein game winning score entries are enterable by more than one participant in said sports game without intervention of a non-participant.

22. A method of scorekeeping with a portable scorekeeping device according to claim 18 wherein said audible sound output includes emitting various tones and musical sound to inform players of various events and conditions encountered during an active game for indicating, said events including score update, game violation and game clock expiry.
